(19) United States
(12) Patent Application Publication
(10) Pub. No.: US 2012/0202543 A1
(43) Pub. Date: Aug. 9, 2012

(54) METHOD FOR PERFORMING PAGING FOR DOWNLINK DATA

(75) Inventors: Ronald G. Murias, Calgary (CA); Lei Wang, San Diego, CA (US)

(73) Assignee: INTERDIGITAL PATENT HOLDINGS, INC., Wilmington, DE (US)

(21) Appl. No.: 13/368,779

(22) Filed: Feb. 8, 2012

Related U.S. Application Data
(60) Provisional application No. 61/441,036, filed on Feb. 9, 2011.

(51) Int. Cl. H04W 72/04; H04W 4/06; H04W 74/00

(52) U.S. Cl. 455/509; 455/515

(57) ABSTRACT

A method and apparatus for paging downlink (DL) data to one or more Machine-to-Machine (M2M) devices. The paging may be performed with network re-entry or with a delayed network re-entry. Further, the paging may be individual device paging or paging for a group of devices.

### CROSS REFERENCE TO RELATED APPLICATION

This application claims the benefit of U.S. Patent Application No. 61/441,036, filed Feb. 9, 2011, the contents of which are hereby incorporated by reference herein.

### FIELD OF INVENTION

This application is related to wireless communications.

### BACKGROUND

For downlink (DL)-only Machine-to-Machine (M2M) transmissions, a base station may need to indicate that an M2M device in idle mode is to awaken to receive a DL burst. The M2M device may not need to acknowledge the DL burst. There exists a need to provide a facility where the M2M device may provide feedback. The M2M device may provide the feedback at select times. For example, the M2M device may provide feedback when the M2M has uplink (UL) data to transmit and needs to perform network re-entry.

### SUMMARY

A method and apparatus for performing paging for downlink (DL) data to one or more Machine-to-Machine (M2M) devices. The paging may be performed with network re-entry or with a delayed network re-entry. Further, the paging may be individual device paging or paging for a group of devices.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A; and

FIG. 1C is a system diagram of an example radio access network and an example core network that may be used within the communications system illustrated in FIG. 1A.

### DETAILED DESCRIPTION

Introduction

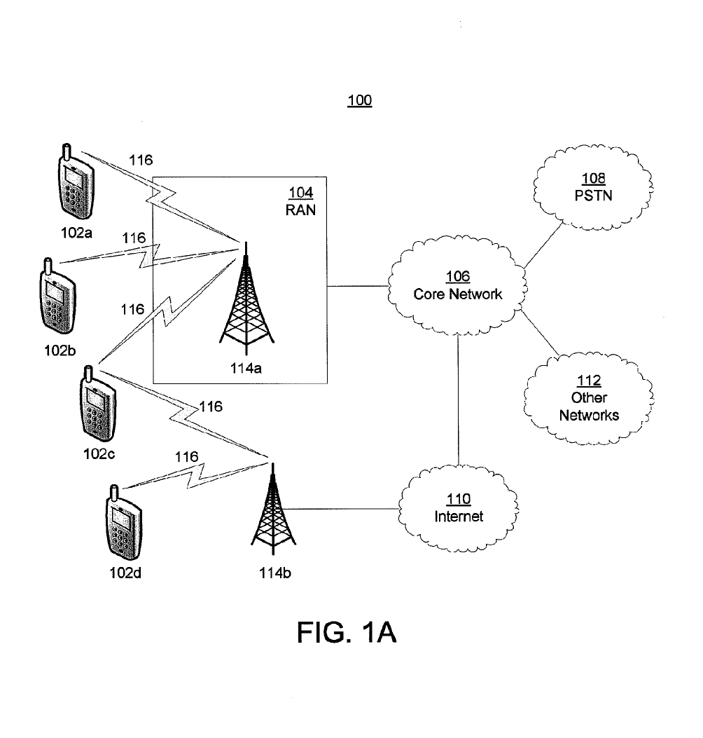

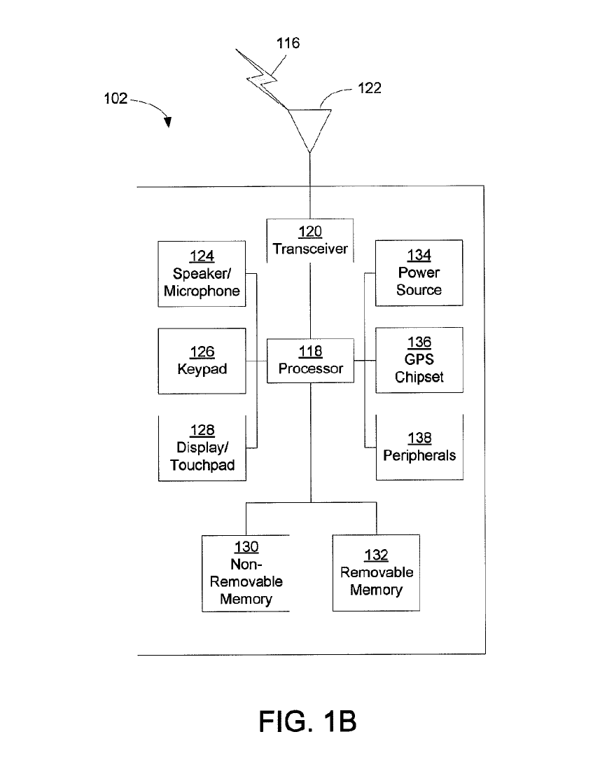

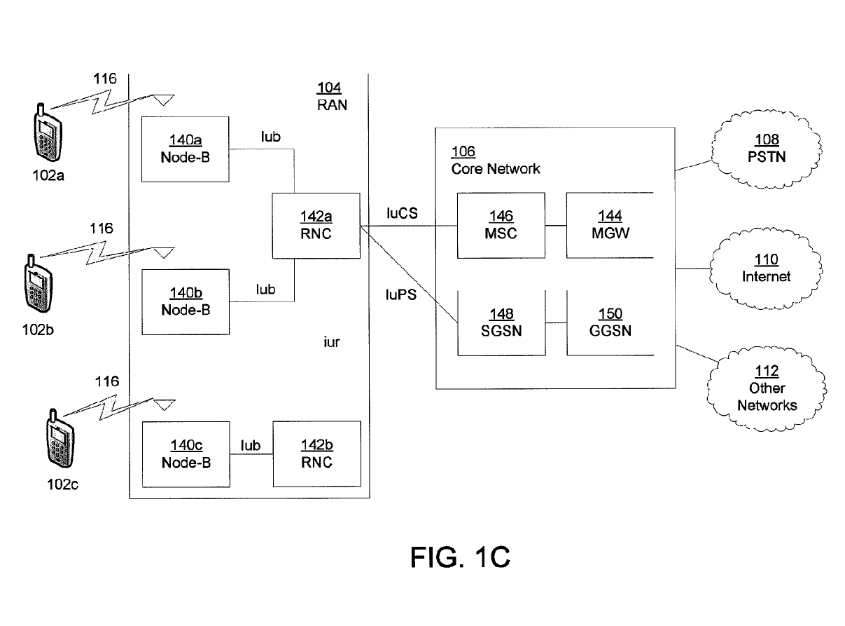

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. The RAN 104 may be an access service network (ASN) that employs IEEE 802.16 radio technology to communicate with the WTRUs 102a, 102b, 102c over the air interface 116. As will be further discussed below, the communication links between the different functional entities of the WTRUs 102a, 102b, 102c, the RAN 104, and the core network 106 may be defined as reference points.

As shown in FIG. 1C, the RAN 104 may include base stations 140a, 140b, 140c,and an ASN gateway 142, though it will be appreciated that the RAN 104 may include any number of base stations and ASN gateways while remaining consistent with an embodiment. The base stations 140a, 140b, 140c may each be associated ith a particular cell (not shown) in the RAN 104 and may each include one or more transceivers for communicating with the WTRUs 102a, 102b, 102c over the air interface 116. In one embodiment, the base stations 140a, 140b, 140c may implement MIMO technology. Thus, the base station 140a, for example, may use multiple antennas to transmit wireless signals to, and receive wireless signals from, the WTRU 102a. The base stations 140a, 140b, 140c may also provide mobility management functions, such as handoff triggering, tunnel establishment, radio resource management, traffic classification, quality of service (QoS) policy enforcement, and the like. The ASN gateway 142 may serve as a traffic aggregation point and may be responsible for paging, caching of subscriber profiles, routing to the core network 106, and the like.

The air interface 116 between the WTRUs 102a, 102b, 102c and the RAN 104 may be defined as an R1 reference point that implements the IEEE 802.16 specification. In addition, each of the WTRUs 102a, 102b, 102c may establish a logical interface (not shown) with the core network 106. The logical interface between the WTRUs 102a, 102b, 102c and the core network 106 may be defined as an R2 reference point, which may be used for authentication, authorization, IP host configuration management, and/or mobility management.

The communication link between each of the base stations 140a, 140b, 140c may be defined as an R8 reference point that includes protocols for facilitating WTRU handovers and the transfer of data between base stations. The communication link between the base stations 140a, 140b, 140c and the ASN gateway 215 may be defined as an R6 reference point. The R6 reference point may include protocols for facilitating mobility management based on mobility events associated with each of the WTRUs 102a, 102b, 100c.

As shown in FIG. 1C, the RAN 104 may be connected to the core network 106. The communication link between the RAN 104 and the core network 106 may defined as an R3 reference point that includes protocols for facilitating data transfer and mobility management capabilities, for example. The core network 106 may include a mobile IP home agent (MIP-HA) 144, an authentication, authorization, accounting (AAA) server 146, and a gateway 148. While each of the foregoing elements are depicted as part of the core network 106, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 144 may provide the WTRUs 102a, 102b, 102c with access to packet-switched networks, such as the Internet 110, to facilitate communications between the WTRUs 102a, 102b, 102c and IP-enabled devices. The AAA server 146 may be responsible for user authentication and for supporting user services. The gateway 148 may facilitate interworking with other networks. For example, the gateway 148 may provide the WTRUs 102a, 102b, 102c with access to circuit-switched networks, such as the PSTN 108, to facilitate communications between the WTRUs 102a, 102b, 102c and traditional land-line communications devices. In addition, the gateway 148 may provide the WTRUs 102a, 102b, 102c with access to the networks 112, which may include other wired or wireless networks that are owned and/or operated by other service providers.

Although not shown in FIG. 1C, it will be appreciated that the RAN 104 may be connected to other ASNs and the core network 106 may be connected to other core networks. The communication link between the RAN 104 the other ASNs may be defined as an R4 reference point, which may include protocols for coordinating the mobility of the WTRUs 102a, 102b, 102c between the RAN 104 and the other ASNs. The communication link between the core network 106 and the other core networks may be defined as an R5 reference, which may include protocols for facilitating interworking between home core networks and visited core networks.

Description

In 802.16m, one message format (e.g., a Table 700—AAI-PAG-ADV message format) includes an action code (1 bit) for a paging advertisement. The action code indicates the need to perform network entry or to perform ranging for a location update.

In M2M, a field (e.g., a “paging reaction” field) may be used as either a “paging with network re-entry” field or a “paging without network re-entry” field.

Further, in M2M, a group paging mode may be defined for paging M2M devices with downlink (DL) data because paging does not required the M2M devices to perform network entry.

An M2M device may receive a paging signal indicating that there is DL data to be received and that the M2M device may receive the DL data without sending an acknowledgement (or response). As a result of using this signaling procedure, the load on the network (fewer devices performing network entry) may be reduced and battery life may be saved (avoiding unnecessary network entry transmissions).

Alternatively, the paging signal may include an indication that the M2M device performs network entry (or re-entry) in response to the page. Further, the M2M device may be required to send an acknowledgement (or response) to the page. For example, a group page may be sent to a group of M2M devices requesting UL data and the page may require network entry (or re-entry) before transmission the M2M devices are able to transmit the UL data.

Further, additional options and alternatives may be used that permit paging with delayed network entry (or re-entry) in order to enhance overall system performance.

In M2M, an individual paging mode may be defined where an M2M device is not required to immediate perform network entry (or re-entry). More specifically, the M2M device is able to receive a DL burst without sending an acknowledgment (or response). The individual paging mode may also be defined such that the M2M device performs delayed network re-entry.

A group paging mode may also be defined where a M2M device performs delayed network re-entry (e.g., a group page requires a non-immediate response) in response to a paging signal. A delayed network re-entry may be used where the acknowledgements (or responses) to DL signals needed from M2M devices in idle mode may tolerate delays.

When paging with a delayed network re-entry scheme is used, the network re-entry procedure may be triggered by a pending UL data transmission and/or a predefined network re-entry triggers, (e.g., max number of pages without network re-entry, max time interval for the delayed responses, or randomly selected waiting time between the DL data reception and max tolerant response delay). Any responses to the paging are transmitted from the M2M device after re-entry to the network.

The use of delayed network re-entry may reduce network congestion and random access collisions when a number of M2M devices need to re-enter the network at the same time upon receiving paging message.

DL Transmissions to Paged Subscribers with Delayed Network Re-Entry

When paging with a delayed network re-entry scheme is used, pending DL transmissions may be transmitted at a delayed time, (e.g., waiting until after the paged M2M device performs network re-entry). A base station may buffer the pending DL transmissions. Any application of the data in the pending DL transmissions must be able to tolerate the delay caused by paging with a delayed network re-entry. As a result, random access collision probability may be reduced because it will be spread over time.

Alternatively, when paging with a delayed network re-entry scheme is used, pending DL transmissions may be transmitted at the same time that is designated for a normal paging scheme, (i.e., without waiting until a paged M2M device performs network re-entry). Here, specific identifiers (IDs) at the MAC layer are required, (e.g., connection ID, station ID, flow ID, etc.), so that the pending DL data may be transmitted.

For pending DL multicast data, the multicast IDs, (e.g., multicast connection ID, multicast station ID, group ID, etc.), may be valid even if a number of M2M devices in a group of M2M devices are in idle mode. As a result, when the idle mode M2M devices are paged for DL multicast data, the multicast IDs are valid and may be used for transmitting the pending DL multicast data to the paged M2M devices without the need to perform immediate network re-entry.

For pending DL unicast data, to support paging with delayed network re-entry or paging without network re-entry, the paged M2M device needs to have proper MAC layer ID(s) for the DL data transmission, (e.g., the MAC layer ID to be used in MAC PDU, and/or the MAC layer ID to be used in the DL resource allocation in which the DL data is transmitted).

A common practice used in idle mode is to de-register the M2M device before entering the idle mode, where the de-registration procedure may release all assigned MAC layer IDs for the M2M device. As a result, the M2M device in idle mode may not have valid MAC layer IDs with the base station that transmitted the paging message.

In one embodiment, the base station may maintain at least one MAC layer ID, (e.g., connection ID or station ID), for each M2M device in idle mode and the at least one MAC layer ID is updated as part of an idle mode location update procedure.

In an alternative embodiment, the base station may assign an ID specially designed for the idle mode M2M devices, (e.g., De-registration ID (DID) in 802.16m,). The ID is then used when the MAC layer identification is required for a DL transmission.

In another alternative embodiment, the base station may reserve one or more MAC layer IDs to be used for the DL transmission to the paged M2M devices with delayed network re-entry or without network re-entry. The reserved MAC layer ID(s) may be shared by multiple idle mode M2M devices, in which case a unique subscriber ID, (e.g., 48-bit MAC address or any forms of its variants), is provided for the DL data transmission, (e.g., included in the data payload).

Aggregated Responses

M2M devices may store several responses and send all the responses at once. If the DL data that caused the page requires some kind of higher layer feedback but does not immediately require the feedback, an M2M device may store one or more message identifiers and send all the feedback at once (e.g., at a time when the M2M device has performed network re-entry for some other required UL).

Alternatively, an M2M device may send a serial number of a last contiguous serial number that the M2M device received or the M2M device may send serial numbers of packets not received. In the latter case, if the M2M device tracks sequential serial numbers and notices a gap in serial numbers, the M2M device may indicate to a base station that a serial number is missing. Again, the M2M device may send an indication to the base station when the M2M device has already performed network entry for some other purpose, or immediately upon noticing the gap.

Base Station Operations

A base station may have an update (e.g., software release, system configuration, etc.) to send to a group of M2M devices that requires an acknowledgement, but not an immediate acknowledgement, from each of M2M devices. The base station may set a “paging with delayed response” flag and send the update to the group of M2M devices. Then, the base station may receive a response from each M2M device with an acknowledgement the next time that each M2M device performs network re-entry. This signaling has the benefit of saving power and also avoids all of the M2M devices performing network re-entry simultaneously only to acknowledge receipt of the update.

The base station may send an update to a group of M2M devices but the base station cannot allow an indefinite period of time before receiving an acknowledgement from each of the M2M devices. Here, an absolute or relative time period may be included in the update. If an M2M device has not performed network re-entry for some other purpose within the time period, then the M2M device may be compelled to perform network re-entry and to transmit the acknowledgment upon expiration of the time period.

If a base station cannot tolerate response delays from the M2M devices, the update may be transmitted using a regular “page with feedback” flag.

A base station may have a “system status” that needs to be shared with all M2M devices in a group of M2M devices. The “system status” may be a status related to the load on the system (e.g., heavy load on the electrical grid, possible brown-outs or black-outs coming, etc.). The base station may transmit a multicast message to relay this information to all the M2M devices in a group of M2M devices. The “system status” may be transmitted with a “paging with delayed response” flag to allow the base station to become aware if any M2M devices did not receive the update when the receipt of the acknowledgment is not time-critical.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use in a wireless communications network for one or more Machine-to-Machine (M2M) devices in idle mode comprising:
receiving a paging message comprising a field indicating paging with network re-entry or or paging with delayed network entry or paging without network re-entry.

2. The method of claim 1, wherein the one or more M2M devices comprise a group and the paging is a group page.

3. The method of claim 1, wherein paging does not require a paged one or more M2M devices to perform network entry to receive DL data.

4. The method of claim 1, wherein paging informs the one or more M2M devices that there is DL data to be received.

5. The method of claim 1, further comprising receiving DL data without performing network entry/re-entry, wherein receipt of the DL data does not need to be acknowledged immediately.

6. The method of claim 1, further comprising performing network re-entry at a later time for UL data transmissions or pre-defined network re-entry trigger triggers.

7. The method of claim 1, wherein the paging is a group page.

8. The method of claim 1, further comprising once performing a delayed network re-entry, wherein acknowledging the receipt of DL data in previous paging listening intervals.

9. The method of claim 1, wherein the paging is an individual paging mode page.

10. The method of claim 1, wherein the paging is a group paging mode page.

11. The method of claim 1, wherein network re-entry is performed by a pre-defined network re-entry trigger.

12. The method of claim 1, further comprising transmitting an acknowledgment indicating the receipt of DL data.

13. The method of claim 1, wherein DL data is transmitted with specific identifiers in the medium access control (MAC) layer.

14. The method of claim 13, wherein DL multicast data uses specific multicast identifiers.

15. The method of claim 13, wherein DL unicast data uses specific unicast identifiers.

16. The method of claim 1, wherein a MAC layer identifier is maintained for each M2M device in an idle mode.

17. The method of claim 1, wherein the MAC layer identifier is updated as part of a location update procedure.

18. The method of claim 1, wherein the MAC layer identifier is assigned to an idle mode M2M device.

19. A method for use in a wireless communications network, the method comprising:
receiving a page for downlink (DL) data for one or more Machine-to-Machine (M2M) devices, wherein the page indicates there are DL data to be received but does not require the one or more M2M devices to perform network entry;
receiving DL data without performing network reentry, wherein the receipt of the DL data is not needed to be acknowledged immediately; and
performing network re-entry at a later time for UL data transmissions or other pre-defined network reentry triggers;.
Acknowledging the receipt of DL data of previous panging listening interval once re-entering the network.
